(19) United States
(12) Patent Application Publication
(10) Pub. No.: US 2019/0392814 A1
(43) Pub. Date: Dec. 26, 2019

(54) VOICE DIALOGUE METHOD AND VOICE DIALOGUE APPARATUS

(71) Applicant: YAMAHA CORPORATION, Hamamatsu-shi (JP)

(72) Inventors: Hiraku KAYAMA, Hamamatsu-shi (JP); Hiroaki MATSUBARA, Hamamatsu-shi (JP); Junya URA, Koganei-shi (JP)

(21) Appl. No.: 16/561,348

(22) Filed: Sep. 5, 2019

Related U.S. Application Data
(63) Continuation of application No. PCT/JP2018/009354, filed on Mar. 9, 2018.

(30) Foreign Application Priority Data
Mar. 9, 2017 (JP) 2017-044557

(51) Int. Cl. G10L 13/033; G10L 15/22; G10L 13/10; G10L 13/04; G10L 15/28; G10L 15/08

(52) U.S. Cl. CPC G10L 13/0335; G10L 15/22; G10L 13/10; G10L 2015/225; G10L 15/28; G10L 15/08; G10L 2015/088; G10L 13/04

(57) ABSTRACT

A voice dialogue apparatus includes a pitch adjusting unit configured to shift pitches of an entire period of a preceding voice, which is reproduced before a dialogue voice for a dialogue, according to a pitch of the dialogue voice, a first reproduction instructing unit configured to instruct reproduction of the preceding voice having been adjusted with the pitch adjusting unit, and a second reproduction instructing unit configured to instruct reproduction of the dialogue voice after the reproduction of the preceding voice with the first reproduction instructing unit.

### CROSS REFERENCE TO RELATED APPLICATION(S)

This application is a continuation of International Patent Application No. PCT/JP2018/009354 filed on Mar. 9, 2018, which claims the benefit of priority of Japanese Patent Application No. 2017-044557 filed on Mar. 9, 2017, the contents of which are incorporated herein by reference in its entirety.

### BACKGROUND OF THE INVENTION

1. Field of the Invention

The present disclosure relates to a voice dialogue.

2. Description of the Related Art

There has been proposed a voice dialogue technology of achieving a dialogue with a user by reproducing a voice of a response to utterance by the user (for example, answer to a question). For example, JP-A-2012-128440 referred to as Patent Literature 1 discloses a technology of analyzing utterance content by performing voice recognition on an utterance voice of a user and synthesizing and reproducing a response voice according to the analysis result.

Patent Literature 1: JP-A-2012-128440

### SUMMARY OF THE INVENTION

However, under known technology including Patent Literature 1, it is actually difficult to achieve a natural voice dialogue which faithfully reflects a tendency of a dialogue between real persons, resulting in a problem that a user may feel mechanical and unnatural impression. The present disclosure, having been contrived bearing in mind the heretofore described circumstances, has for its object to achieve a natural voice dialogue.

In order to solve the aforesaid problem, a voice dialogue method according to an aspect of the present disclosure includes: a pitch adjusting step of shifting pitches of an entire period of a preceding voice, which is reproduced before a dialogue voice for a dialogue, according to a pitch of the dialogue voice; a first reproduction instructing step of instructing reproduction of the preceding voice having been adjusted in the pitch adjusting step; and a second reproduction instructing step of instructing reproduction of the dialogue voice after the reproduction of the preceding voice by the first reproduction instructing step.

A voice dialogue apparatus according to an aspect of the present disclosure includes: a pitch adjusting unit configured to shift an entire period of a preceding voice, which is reproduced before a dialogue voice for a dialogue, according to a pitch of the dialogue voice; a first reproduction instructing unit configured to instruct reproduction of the preceding voice having been adjusted with the pitch adjusting unit; and a second reproduction instructing unit configured to instruct reproduction of the dialogue voice after the reproduction of the preceding voice with the first reproduction instructing unit.

### BRIEF DESCRIPTION OF THE DRAWINGS

FIG. 1 is a configuration diagram of a voice dialogue apparatus of a first embodiment.

FIG. 2 is an explanatory diagram of an interjection voice and a response voice in the first embodiment.

FIG. 3 is a flowchart of a processing executed with a control device in the first embodiment.

FIG. 4 is an explanatory diagram of an utterance voice, two interjection voices, and a response voice in a second embodiment.

FIG. 5 is a flowchart of a processing executed with a control device in the second embodiment.

### DETAILED DESCRIPTION OF THE EXEMPLARY EMBODIMENTS

### First Embodiment

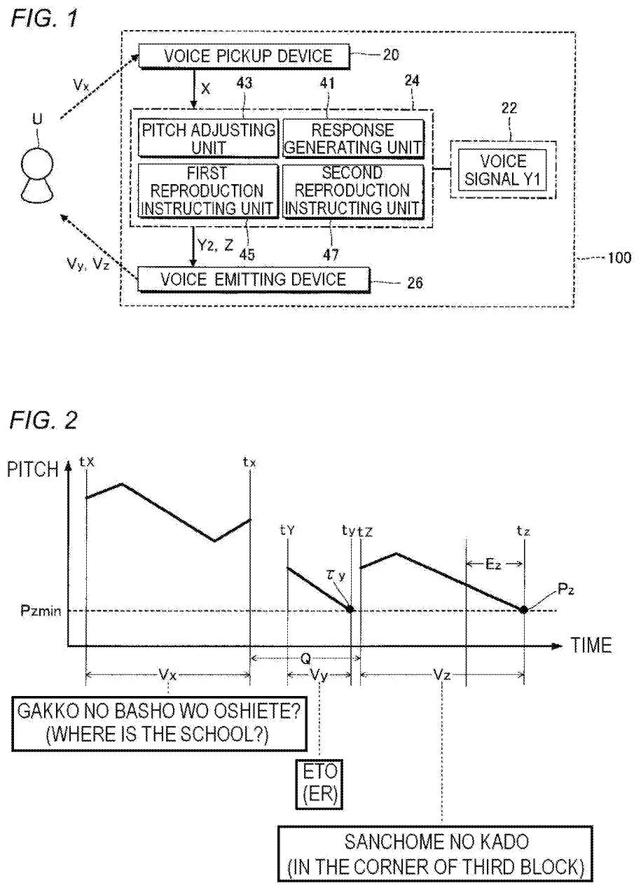

FIG. 1 is a configuration diagram of a voice dialogue apparatus 100 according to a first embodiment of the present disclosure. The voice dialogue apparatus 100 of the first embodiment is a voice dialogue system which reproduces a voice of response (hereinafter referred to as a “response voice”) Vz to a voice uttered by a user U (hereinafter referred to as an “utterance voice”) Vx. For example, a portable information processing apparatus such as a mobile phone or a smartphone, or an information processing apparatus such as a personal computer is used as the voice dialogue apparatus 100. Further, the voice dialogue apparatus 100 can also be achieved with a form of a toy imitating the exterior of an animal or the like (for example, a doll such as a stuffed animal) or a robot.

An utterance voice (speech voice) Vx is a voice of utterance including, for example, asking (questioning) and talking, and a response voice (an example of a dialogue voice) Vz is a voice of a response including a response to asking or an answer to talking. A response voice (dialogue voice) Vz of the first embodiment is a voice having particular meaning which is formed of one or more words. For example, a response voice Vz to an utterance voice Vx “gakko no basho wo oshiete?” (“where is the school?”) is supposed to be “sanchome no kado” (“in the corner of third block”). In a dialogue between real persons, any voice (typically, a voice of an interjection) tends to be uttered by a dialogue partner between an utterance voice by an utterer and a response voice pronounced by the dialogue partner. Thus, if a response voice Vz is reproduced just after an utterance voice Vx, a user U may feel mechanical and unnatural impression. As shown in FIG. 2 by way of example, the voice dialogue apparatus 100 of the first embodiment therefore reproduces a voice of an interjection (hereinafter referred to as an “interjection voice”) Vy in a period (hereinafter referred to as a “standby period”) Q from the generation of an utterance voice Vx (for example, pronunciation termination time of the utterance voice Vx) to the generation of a response voice Vz (for example, reproducing start time of the response voice Vz). That is, an interjection voice (an example of a preceding voice) Vy is a voice reproduced prior to a response voice (dialogue voice) Vz.

An interjection voice (preceding voice) Vy is a voice representing an interjection. An interjection is an independence word having no conjunction (exclamation or interjection) used independently of another phrase. Specifically, examples of an interjection may include words such as “un” and “ee” (“aha” or “right” in English) representing an agreement to utterance, words such as “eto” and “ano” (“um” or “er” in English) representing a faltering (hesitation to response), words such as “hai” and “iie” (“yes” or “no” in English) representing a response (affirmation or denial to a question), words such as “aa” and “oo” (“ah” or “woo” in English) representing impression of an utterer, and words such as “e?” and “nani?” (“pardon?” or “sorry?” in English) meaning asking-back (asking again) to utterance.

A response voice (dialogue voice) Vz is positioned as a necessary response to an utterance voice Vx, whereas an interjection voice (preceding voice) Vy is positioned as an optional response (a response which may be omitted in a dialogue) which is supplementarily (subsidiarily) or additionally pronounced prior to a response voice (dialogue voice) Vz. An interjection voice (pre-voice) Vy may be restated as another voice not contained in a response voice Vz. The first embodiment shows by way of example a case in which the interjection voice Vy representing the faltering “eto” (“er”) is reproduced with respect to the utterance voice Vx of the asking “gakko no basho wo oshiete?” (“where is the school?”), and the response voice Vz of the response “sanchome no kado” (“in the corner of third block”) is generated after the interjection voice Vy.

As shown in FIG. 1 by way of example, the voice dialogue apparatus 100 of the first embodiment includes a voice pickup device 20, a storage device 22, a control device 24, and a voice emitting device 26. The voice pickup device 20 (for example, a microphone) generates a signal (hereinafter referred to as an “utterance signal”) X representing an utterance voice Vx of a user U. An A/D converter, which performs analog-to-digital conversion of an utterance signal X generated from the voice pickup device 20, is not illustrated for convenience. The voice emitting device 26 (for example, a speaker or a headphone) reproduces a voice according to a signal supplied from the control device 24. The voice emitting device 26 of the first embodiment reproduces an interjection voice Vy and a response voice Vz according to an instruction from the control device 24.

The storage device 22 stores a program executed with the control device 24 and various kinds of data used with the control device 24. For example, the known recording medium such as a semiconductor recording medium or a magnetic recording medium, or a combination of a plurality of recording media can be optionally adopted as the storage device 22. Specifically, the storage device 22 stores a voice signal Y1 representing an interjection voice Vy of the faltering. The following explanation shows by way of example a case in which the voice signal Y1 representing the interjection voice Vy of optional prosody representing the faltering “eto” (“er”) is stored in the storage device 22. In this embodiment, a pitch is used as the prosody. The voice signal Y1 is recorded in advance and stored in the storage device 22 as a voice file of an optional format such as a WAV format.

The control device 24 is an arithmetic processing device (for example, a CPU) which totally controls each element of the voice dialogue apparatus 100. The control device 24 executes the program stored in the storage device 22, thereby achieving a plurality of functions (a response generating unit 41, a pitch adjusting unit 43 (prosody adjusting unit), a first reproduction instructing unit 45, and a second reproduction instructing unit 47) for establishing a dialogue with a user U. It may also be possible to adopt a configuration where the functions of the control device 24 are achieved with a plurality of devices (that is, a system) or a configuration where part of the functions of the control device 24 is shared with a dedicated electronic circuit.

The response generating unit 41 of FIG. 1 generates a response voice Vz to an utterance voice Vx. The response generating unit 41 of the first embodiment performs voice recognition on an utterance signal X and performs voice synthesis utilizing the result of the voice recognition, thereby generating a response signal Z representing the response voice Vz. Specifically, firstly, the response generating unit 41 specifies the content of the utterance voice Vx (hereinafter referred to as “utterance content”) by the voice recognition on the utterance signal X generated from the voice pickup device 20. In the first embodiment, the utterance content of the utterance voice Vx “gakko no basho wo oshiete?” (“where is the school?”) is specified. As the voice recognition on the utterance signal X, the known technology such as a recognition technology, which utilizes an acoustic model such as HMM (Hidden Markov Model) and a language model representing linguistic constraints, can be optionally adopted.

Secondary, the response generating unit 41 analyzes the meaning of the specified utterance content (phonemes) and generates a character sequence of a response (hereinafter referred to as a “response character sequence”) corresponding to the utterance content. The known natural language processing technology can be optionally adopted in order to generate a response character sequence. In the first embodiment, the response character sequence “sanchome no kado” (“in the corner of third block”) corresponding to the utterance voice Vx “gakko no basho wo oshiete?” (“where is the school?”) can be generated. Thirdly, the response generating unit 41 generates a response signal Z representing a voice uttering a generated response character sequence (that is, a response voice Vz). The known voice synthesis technology can be optionally adopted in order to generate a response signal Z. For example, voice pieces corresponding to a response character sequence are sequentially selected from a set of plural voice pieces which is obtained in advance from a recorded voice of a particular utterer, and a response signal Z is generated by mutually coupling the selected voice pieces on a temporal axis. Pitches of a response voice Vz represented by a response signal Z may change according to, for example, content of a response character sequence or content of a voice synthesis processing. The generated response signal Z is supplied to the voice emitting device 26 with the second reproduction instructing unit 47. The method of generating a response signal Z is not limited to the voice synthesis technology. For example, a configuration can also be preferably adopted in which a plurality of response signals Z different in utterance content is stored in the storage device 22, a response signal Z corresponding to the specified utterance content is selected out of the plurality of response signals Z and supplied to the voice emitting device 26. The plurality of responses signals Z are each recorded in advance and stored in the storage device 22 as a voice file of an optional format such as the WAV format.

When a real person utters a plurality of voices sequentially, pitches of these voices are mutually affected. For example, a pitch of a preceding voice depends on a pitch of a subsequent voice. In particular, when an utterer sequentially utters an interjection voice and a response voice, a pitch of the interjection voice tends to depend on a pitch of the immediate response voice. In the first embodiment, an interjection voice Vy having a pitch according to a pitch of a response voice Vz is thus reproduced.

The pitch adjusting unit 43 of FIG. 1 adjusts the pitch of an interjection voice Vy according to the pitch Pz of a response voice Vz. The pitch adjusting unit 43 of the first embodiment adjusts the pitch of a voice signal Y1 stored in the storage device 22 according to the pitch Pz of a response voice Vz, thereby generating a voice signal Y2 of an interjection voice Vy.

The first reproduction instructing unit 45 instructs the reproduction of an interjection voice Vy, the pitch of which has been adjusted with the pitch adjusting unit 43, in a standby period Q. Specifically, the first reproduction instructing unit 45 supplies the voice signal Y2 of the interjection voice Vy “eto” (“er”) to the voice emitting device 26. As shown in FIG. 2 by way of example, the reproduction of the interjection voice Vy is instructed at a time point tY on the way of the standby period Q from an end point tx of the utterance voice Vx to a time point tZ where the reproduction of the response voice Vz is started.

The second reproduction instructing unit 47 instructs the reproduction of the response voice Vz after the reproduction of the interjection voice Vy with the first reproduction instructing unit 45. Specifically, the second reproduction instructing unit 47 supplies the response signal Z generated with the response generating unit 41 to the voice emitting device 26 after the reproduction of the interjection voice Vy (typically, immediately after the reproduction of the interjection voice Vy).

The voice emitting device 26 sequentially reproduces the interjection voice Vy “eto” (“er”), which is represented by the voice signal Y2 supplied from the first reproduction instructing unit 45, and the response voice Vz “sanchome no kado” (“in the corner of the third block”), which is represented by the response signal Z supplied from the second reproduction instructing unit 47. An A/D converter, which performs analog-to-digital conversion of a voice signal Y2 and a response signal Z, is not illustrated for convenience. As is understood from the above explanation, when a user U utters the utterance voice Vx “gakko no basho wo oshiete?” (“where is the school?”), the interjection voice Vy “eto” (“er”) representing the faltering is reproduced, and the response voice Vz “sanchome no kado” (“in the corner of the third block”) is reproduced subsequent to the reproduction of the interjection voice Vy.

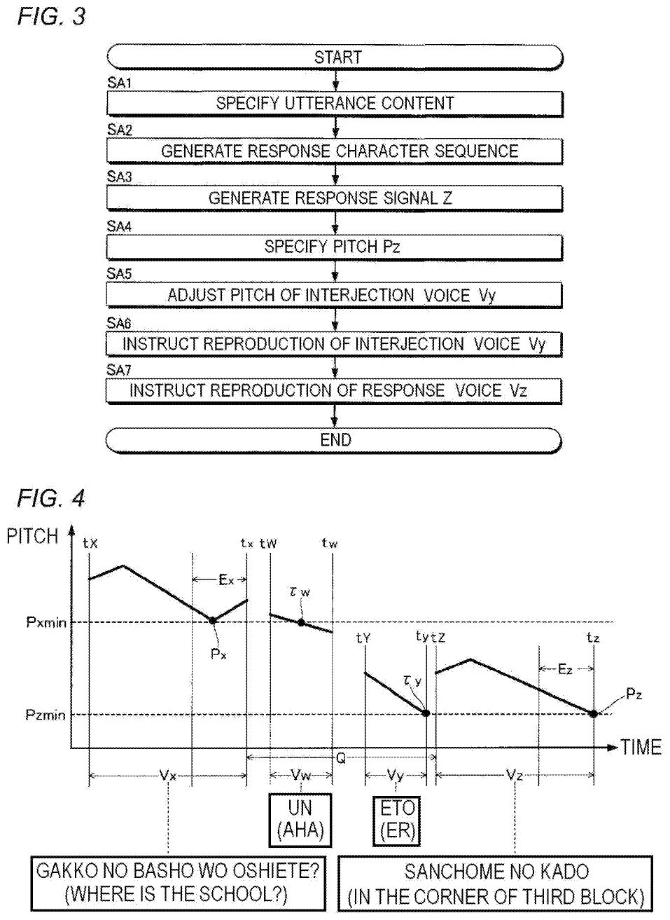

FIG. 3 is a flowchart of a processing executed with the control device 24 in the first embodiment. The processing of FIG. 3 is started, for example, in response to the termination of an utterance voice Vx of a user U.

When the processing of FIG. 3 is started, the response generating unit 41 acquires the utterance signal X representing the utterance voice Vx “gakko no basho wo oshiete?” (“where is the school?”) and specifies the utterance content by performing the voice recognition on the utterance signal X (SA1). The response generating unit 41 analyzes the meaning of the specified utterance content and generates the response character sequence “sanchome no kado” (“in the corner of the third block”) corresponding to the utterance content (SA2). The response generating unit 41 generates the response signal Z representing the response voice Vz which utters the generated response character sequence “sanchome no kado” (“in the corner of the third block”) (SA3).

The pitch adjusting unit 43 specifies the pitch Pz of the response voice Vz (SA4). As shown in FIG. 2 by way of example, the pitch Pz is, for example, the minimum value (hereinafter referred to as a “minimum pitch”) Pzmin of pitches in a last interval Ez including an end point tz out of the response voice Vz. The last interval Ez is, for example, a partial interval over a predetermined length (for example, several seconds) before the end point tz out of the response voice Vz. For example, as is understood from FIG. 2, in the response voice Vz of the declarative sentence “sanchome no kado” (“in the corner of the third block”), the pitch tends to decrease monotonously toward the end point tz. Thus, the pitch (minimum pitch Pzmin) at the end point tz of the response voice Vz is specified as the pitch Pz. The last interval Ez is not limited to an interval of a predetermined length before the end point tz out of the response voice Vz. For example, an interval of a predetermined ratio including the end point tz out of the response voice Vz can also be defined as the last interval Ez. Alternatively, it is also possible to define the last interval Ez in such a way that a time point near the end point tz (a past time point than the end point tz) out of the response voice Vz is set as an end point (that is, the last interval Ez is specified excluding an interval near the end point tz out of the response voice Vz). As is understood from the above examples, the last interval Ez is comprehensively represented as an interval near the end point tz out of the response voice Vz.

The pitch adjusting unit 43 adjusts the pitch of the interjection voice Vy “eto” (“er”) according to the pitch Pz (minimum pitch Pzmin) which is specified for the response voice Vz “sanchome no kado” (“in the corner of the third block”) (SA5). In the case of a real dialogue, the pitch near the end point of an interjection voice, which is uttered by a dialogue partner in response to an utterance voice of an utterer, tends to match the minimum pitch near the end point of a response voice, which is uttered by the dialogue partner immediately after the interjection voice. The pitch adjusting unit 43 of the first embodiment thus adjusts the pitch of the interjection voice Vy “eto” (“er”) so as to match the pitch Pz specified for the response voice Vz “sanchome no kado” (“in the corner of the third block”). Specifically, the pitch adjusting unit 43 adjusts the pitch of an interjection voice Vy so that the pitch at a particular time point (hereinafter referred to as a “target point”) τy on the temporal axis out of a voice signal Y1 representing the interjection voice Vy matches the pitch Pz of a response voice Vz, thereby generating a voice signal Y2 representing the interjection voice Vy. A preferred example of the target point τy is an end point ty of an interjection voice Vy. Specifically, as shown in FIG. 2 by way of example, the pitch adjusting unit 43 adjusts pitches (performs pitch-shift) over the entire period of a voice signal Y1 so that the pitch at the end point ty of the voice signal Y1 representing the interjection voice Vy “eto” (“er”) matches the pitch Pz of a response voice Vz, thereby generating a voice signal Y2. The known technology can be optionally adopted for the adjustment of pitches. The target point τy is not limited to the end pint ty of an interjection voice Vy. For example, the pitches can also be adjusted using, as the target point τy, a start point (time point tY) of an interjection voice Vy.

In the standby period Q, the first reproduction instructing unit 45 supplies the voice signal Y2 generated with the pitch adjusting unit 43 to the voice emitting device 26, thereby instructing the reproduction of the interjection voice Vy “eto” (“er”), the pitch of which has been adjusted (SA6). The second reproduction instructing unit 47 supplies the response signal Z generated with the response generating unit 41 to the voice emitting device 26 after the reproduction of the interjection voice Vy “eto” (“er”), thereby instructing the reproduction of the response voice Vz “sanchome no kado” (“in the corner of the third block”) (SA7). With the processing described above, the voice dialogue is achieved in which the interjection voice Vy “eto” (“er”) and the response voice Vz “sanchome no kado” (“in the corner of the third block”) are sequentially reproduced in response to the utterance voice Vx “gakko no basho wo oshiete?” (“where is the school?”) uttered by a user U.

As explained above, in the first embodiment, an interjection voice Vy is reproduced before the reproduction of a response voice Vz to an utterance voice Vx. Thus, a natural voice dialogue imitating a tendency of a real dialogue, in which any voice (typically, an interjection voice) by a dialogue partner is uttered between an utterance voice by an utterer and a response voice uttered by the dialogue partner, can be achieved. In the first embodiment, the pitch of an interjection voice Vy is adjusted according to the pitch of a response voice Vz, and thus a natural voice dialogue imitating a tendency of a real utterer, in which the pitch of an interjection voice is affected by the pitch of a response voice uttered immediately after the interjection voice, can be achieved.

### Second Embodiment

A second embodiment of the present disclosure will be explained. In each embodiment explained below by way of example, elements identical or similar to those of the first embodiment in their operations or functions are denoted by the symbols common to those of the first embodiment, and detailed explanation of the elements is omitted as appropriate.

The voice dialogue apparatus 100 of the first embodiment reproduces an interjection voice (an example of a preceding voice) Vy during the standby period Q from an utterance voice Vx to the generation of a response voice Vz. In contrast, as shown in FIG. 4 by way of example, a voice dialogue apparatus 100 of the second embodiment reproduces in the standby period Q, in addition to the reproduction of an interjection voice (an example of a preceding voice) Vy as with the first embodiment, another interjection voice (an example of an initial voice) Vw before the reproduction of the interjection voice Vy. That is, an interjection voice (initial voice) Vw is a voice reproduced before an interjection voice (preceding voice) Vy. As is understood from the above explanation, an interjection voice Vw and an interjection voice Vy are sequentially reproduced in the standby period Q. An interjection voice Vw is a voice which means an interjection as with an interjection voice Vy. The utterance content (phonemes) of an interjection voice Vw in the second embodiment differs from the utterance content of an interjection voice Vy.

In a situation of a real dialogue, a plurality of interjection voices is uttered by a dialogue partner before the utterance of a response voice in some cases depending on the utterance content of an utterer. For example, in a real dialogue, when the utterance voice “gakko no basho wo oshiete?” (“where is the school?”) is uttered, the response voice “sanchome no kado” (“in the corner of the third block”) is uttered after sequentially uttering the interjection voice “un” (“aha”) representing the agreement to the utterance voice and the interjection voice representing the faltering “eto” (“er”). In view of the above described tendency, the voice dialogue apparatus 100 of the second embodiment reproduces a plurality of interjection voices Vw, Vy in the standby period Q, as escribed above. The second embodiment shows by way of example a case in which the interjection voice Vw “un” (“aha”) representing the agreement and the interjection voice Vy “eto” (“er”) representing the faltering are sequentially reproduced in the standby period Q.

In a real dialogue, when a plurality of interjection voices is uttered by a dialogue partner during a period from an utterance voice by an utterer to a response voice Vz by a dialogue partner, there is a tendency that the pitch of a voice uttered immediately after the utterance voice depends on the pitch of the utterance voice and the pitch of a voice uttered immediately before a respond voice depends on the pitch of the response voice. On the premise of the above described tendency, the second embodiment reproduces an interjection voice Vw having a pitch according to the pitch of an utterance voice Vx and an interjection voice Vy having a pitch according to the pitch of a response voice Vz.

The voice dialogue apparatus 100 of the second embodiment includes, as with the first embodiment, the voice pickup device 20, the storage device 22, the control device 24, and the voice emitting device 26. The voice pickup device 20 of the second embodiment generates an “utterance signal X representing an utterance voice Vx of a user U as with the first embodiment. The storage device 22 of the second embodiment stores, in addition to the voice signal Y1 representing the interjection voice Vy “eto” (“er”) as with the first embodiment, a voice signal W1 representing the interjection voice Vw “un” (“aha”) with a predetermined pitch.

The control device 24 of the second embodiment achieves, as with the first embodiment, a plurality of functions (the response generating unit 41, the pitch adjusting unit 43, the first reproduction instructing unit 45, and the second reproduction instructing unit 47) for establishing a dialogue with a user U. The response generating unit 41 of the second embodiment generates the response voice Vz “sanchome no kado” (“in the corner of the third block”) to the utterance voice Vx “gakko no basho wo oshiete?” (“where is the school?”) as with the first embodiment. Specifically, the response generating unit 41 specifies utterance content by performing the voice recognition on the utterance signal X of the utterance voice Vx “gakko no basho wo oshiete?” (“where is the school?”) and generates a response signal Z representing a response character sequence to the utterance content.

The pitch adjusting unit 43 (prosody adjusting unit) of the second embodiment adjusts the pitch of an interjection voice Vw according to the pitch Px of an utterance voice Vx of a user U and also adjusts the pitch of an interjection voice Vy according to the pitch Pz of a response voice Vz. As for the adjustment of the pitch of an interjection voice Vw, the pitch adjusting unit 43 adjusts the pitch of the voice signal W1 stored in the storage device 22 according to the pitch Px of an utterance voice Vx, thereby generating a voice signal W2 of an interjection voice Vw. As for the adjustment of the pitch of an interjection voice Vy, as with the first embodiment, the pitch adjusting unit 43 adjusts the initial interjection voice Vy “eto” (“er”) represented by the voice signal Y1 according to the pitch Pz of a response voice Vz, thereby generating the voice signal Y2 representing the interjection voice Vy “eto” (“er”).

The first reproduction instructing unit 45 of the second embodiment instructs the reproduction of the interjection voice Vw “un” (“aha”) and the interjection voice Vy “eto” (“er”), the pitches of which have been adjusted with the pitch adjusting unit 43, in the standby period Q. That is, the voice signal W2 representing the interjection voice Vw and the voice signal Y2 representing the interjection voice Vy are supplied to the voice emitting device 26. Specifically, the first reproduction instructing unit 45 instructs the reproduction of the interjection voice Vw in the standby period Q of FIG. 4 and the reproduction of the interjection voice Vy in the standby period Q after the reproduction of the interjection voice Vw.

The second reproduction instructing unit 47 of the second embodiment supplies, as with the first embodiment, the response signal Z generated with the response generating unit 41 to the voice emitting device 26 after the reproduction of the interjection voice Vy, thereby instructing the reproduction of the response voice Vz after the reproduction of the interjection voice Vy.

The voice emitting device 26 sequentially reproduces the interjection voice Vw “un” (“aha”) and the interjection voice Vy “eto” (“er”) which are respectively represented by the voice signal W2 and the voice signal Y2 supplied from the first reproduction instructing unit 45, and thereafter reproduces the response voice Vz “sanchome no kado” (“in the corner of the third block”) which is represented by the response signal Z supplied from the second reproduction instructing unit 47. The reproduction of the interjection voice Vw is instructed at a time point tW on the way of the standby period Q from the end point tx of the utterance voice Vx to a time point tZ where the reproduction of the response voice Vz is started, and the reproduction of the interjection voice Vy is instructed at a time point tY on the way of the period from the end point tx to the time point tZ. As is understood from the above explanation, when a user U utters the utterance voice Vx “gakko no basho wo oshiete?” (“where is the school?”), the response voice Vz “sanchome no kado” (“in the corner of the third block”) is reproduced subsequent to the reproduction of the interjection voice Vw “un” (“aha”) representing the agreement and the interjection voice Vy “eto” (“er”) representing the faltering.

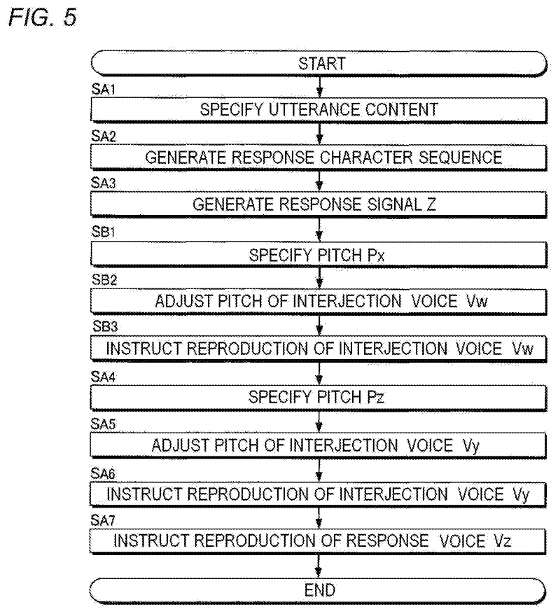

FIG. 5 is a flowchart of a processing executed with the control device 24 in the second embodiment. The second embodiment adds steps (SB1 to SB3) for reproducing an interjection voice Vw to steps SA1 to SA7 shown by way of example in the first embodiment. The steps from the start of the processing to step (SA3) for generating a response signal Z are the same as those of the first embodiment.

The pitch adjusting unit 43 specifies the pitch Px of the utterance voice Vx “gakko no basho wo oshiete?” (“where is the school?”) from the utterance signal X generated with the voice pickup device 20 (SB1). As shown in FIG. 4 by way of example, the pitch Px is, for example, the minimum value (hereinafter referred to as a “minimum pitch”) Pxmin of pitches in a last interval Ex including an end point tx out of the utterance voice Vx. The last interval Ex is, for example, a partial interval over a predetermined length (for example, several seconds) before the end point tx out of the utterance voice Vx. For example, as is understood from FIG. 4, in the utterance voice Vx of the interrogate sentence “gakko no basho wo oshiete?” (“where is the school?”), the pitch tends to increase near the end point tx. Thus, the pitch (minimum pitch Pxmin) at the minimum point, at which the pitch transition of the utterance voice Vx changes from reduction to increase, is specified as the pitch P. The last interval Ex is not limited to an interval of a predetermined ratio including the end point tx out of the utterance voice Vx. For example, an interval of a predetermined length before the end point tx out of the utterance voice Vx can also be defined as the last interval Ex. Alternatively, it is also possible to define the last interval Ex in such a way that a time point near the end point tx (a past time point than the end point tx) out of the utterance voice Vx is set as an end point (that is, the last interval Ex is specified excluding an interval near the end point tx out of the utterance voice Vx). As is understood from the above examples, the last interval Ex is comprehensively represented as an interval near the end point tx out of the utterance voice Vx.

The pitch adjusting unit 43 adjusts the pitch of the interjection voice Vw “un” (“aha”) according to the pitch Px (minimum pitch Pxmin) which is specified for the utterance voice Vx “gakko no basho wo oshiete?” (“where is the school?”) (SB2). Specifically, the pitch adjusting unit 43 of the second embodiment adjusts the pitch of the interjection voice Vw so that the pitch at a particular time point (hereinafter referred to as a “target point”) τtw on the temporal axis out of the voice signal W1 of the interjection voice Vw matches the minimum pitch Pxmin specified for the utterance voice Vx, thereby generating the voice signal W2 representing the interjection voice Vw “un” (“aha”). A preferred example of the target point τw is a start point of a particular mora (typically, the last mora) out of plural morae which constitute the interjection voice Vw. For example, supposing the voice signal W1 of the interjection voice Vw “un” (“aha”), as is understood from FIG. 4, the voice signal W2 of the interjection voice Vw is generated by adjusting the pitches (pitch shift) over the entire period of the voice signal W1 so that the pitch at the start point of “ha”, which is the last mora of the voice signal W1, matches the minimum pitch Pxmin. The known technology can be optionally adopted for the adjustment of pitches. The target point τw is not limited to the start point of the last mora out of the interjection voice Vw. For example, the pitches can also be adjusted using, as the target point τw, the start point (time point tW) or the end point tw of the interjection voice Vw.

In the standby period Q, the first reproduction instructing unit 45 supplies the voice signal W2 generated with the pitch adjusting unit 43 to the voice emitting device 26, thereby instructing the reproduction of the interjection voice Vw “un” (“aha”), the pitch of which has been adjusted (SB3). As with the first embodiment, after the reproduction of the interjection voice Vw is instructed, the instruction of the pitch adjustment and reproduction of the interjection voice Vy (SA4 to SA6) and the instruction of the reproduction of the response voice Vz (SA7) are sequentially executed.

The effect similar to that of the first embodiment is also achieved in the second embodiment. In the second embodiment, a plurality of interjection voices Vw, Vy are reproduced in the standby period Q, and so a voice dialogue more properly imitating a real dialogue can be achieved. In the second embodiment, an interjection voice Vw, which is reproduced immediately after an utterance voice Vx, is reproduced with a pitch according to the pitch Px of the utterance voice Vx, and an interjection voice Vy, which is reproduced immediately before a response voice Vz, is reproduced with a pitch according to the pitch Pz of the response voice Vz, whereby a natural voice dialogue closer to a real dialogue can be imitated.

### MODIFICATION EXAMPLES

The embodiments described above can be modified in various manners. Concrete modification modes will be described by way of example. Two or more modes selected optionally from the following modes can be combined suitably in a range where they do not conflict with each other.

(1) In each embodiment described above, a response voice Vz to an utterance voice Vx is reproduced after the reproduction of an interjection voice Vy, but it may also be supposed that the voice dialogue device 100 reproduces an interjection voice Vy and a response voice Vz in a state where a user U does not utter an utterance voice Vx. That is, an utterance voice Vx can be omitted. For example, the voice dialogue device 100 reproduces the voice “kyo no tenki ha?” (“how is today's weather?”) asking a user U, after reproducing the interjection voice Vy “eto” (“er”). Alternatively, a configuration can also be adopted in which a response voice Vz representing a response to a character sequence, which is inputted via an input device by a user U, is reproduced. As is understood from the above explanation, a voice reproduced after the reproduction of an interjection voice Vy is not limited to a response voice to an utterance voice Vx, but is comprehensively represented as a dialogue voice for a dialogue (that is, constituting a dialogue). The response voice Vz in each embodiment described above is an example of the dialogue voice.

(2) In each embodiment described above, an interjection voice Vy is reproduced before the reproduction of a response voice Vz, but content of a voice reproduced before the reproduction of a response voice Vz is not limited to the example described above (that is, an interjection). For example, it can also be supposed that a voice having a particular meaning (for example, a sentence constituted of plural words) is reproduced before the reproduction of a response voice Vz. As is understood from the above explanation, a voice reproduced before the reproduction of a response voice Vz is comprehensively represented as a preceding voice which is reproduced before the response voice Vz. An interjection voice Vy is an example of the preceding voice. Also, as for the interjection voice Vw of the second embodiment, an interjection voice Vw is reproduced before the reproduction of an interjection voice Vy, but content of a voice reproduced before the reproduction of an interjection voice Vy is not limited to the example described above (that is, an interjection). A voice reproduced before the reproduction of an interjection voice Vy is not limited to a voice representing an interjection, but is comprehensively represented as an initial voice which is reproduced before the interjection voice Vy. The interjection voices Vw in the embodiments described above are examples of the initial voice.

(3) In the second embodiment, two interjection voices Vw, Vy are reproduced in the standby period Q, but a configuration can also be adopted in which three or more voices are reproduced in the standby period Q. A preferable configuration is that, irrespective of the total number of voices in the standby period Q, a voice reproduced immediately after an utterance voice Vx is adjusted according to the pitch Px of the utterance voice Vx and a voice just before a response voice Vz is adjusted according to the pitch Pz of the response voice Vz. According to the above-described configuration, as with the embodiments described above, it is possible to ensure the effect that a natural voice dialogue closer to a real dialogue can be imitated. The difference in the content (phonemes) of plural voices reproduced in the standby period Q is ignored.

(4) Each embodiment described above shows by way of example the configuration in which the pitch at the target point τy out of an interjection voice Vy is matched to the minimum pitch Pzmin in the last interval Ez of a response voice Vz, but the relation between the pitch at the target point τy of the interjection voice Vy and the pitch Pz of the response voice Vz is not limited to the aforesaid example (the relation in which both pitches match with each other). For example, the pitch at the target point τy of an interjection voice Vy can be matched to a pitch which is obtained by adding or subtracting a predetermined adjustment value (an offset) to or from the pitch Pz of a response voice Vz. The adjustment value is a fixed value (for example, a numerical value corresponding to a musical interval of a fifth or the like with respect to the minimum pitch Pzmin) set in advance or a variable value according to an instruction from a user U. In the second embodiment, too, the relation between the pitch at the target point τW of an interjection voice Vw and the minimum pitch Pxmin of an utterance voice Vx is not limited to the relation in which both pitches match with each other. In the second embodiment, too, when adopting a configuration in which the adjustment value is set to a numerical value corresponding to an integral multiple of an octave, an interjection voice Vw having a pitch wherein the minimum pitch Pxmin is octave-shifted is reproduced. It is also possible, in response to an instruction from a user U, to switch whether or not to apply the adjustment value.

(5) In each embodiment described above, the pitch of an interjection voice Vy is adjusted according to the minimum pitch Pzmin in the last interval Ez of a response voice Vz, but the pitch Pz at an optional time point in a response voice Vz can be used for adjusting the pitch of an interjection voice Vy. However, from the standpoint of achieving a natural voice dialogue close to a real dialogue, a configuration can preferably be adopted in which the adjustment is performed according to the pitch Pz (particularly, the minimum pitch Pzmin) in the last period (that is, near the end point tz) of a response voice Vz. Also, in the second embodiment, the pitch Px at an optional time point in an utterance voice Vx can be used for the adjustment of pitch of an interjection voice Vw.

(6) In each embodiment described above, a configuration can also be preferably adopted in which the first reproduction instructing unit 45 determines according to an utterance voice Vx whether or not to instruct the reproduction of an interjection voice Vy, For example, it is also possible to determine according to utterance content whether or not to instruct the reproduction of an interjection voice Vy. The first reproduction instructing unit 45, for example, instructs the reproduction of an interjection voice Vy when utterance content is an interrogative sentence, but does not instruct the reproduction of the interjection voice Vy when the utterance content is a declarative sentence. It is also possible to determine according to the time length of an utterance voice Vx whether or not to instruct the reproduction of an interjection voice Vy. The first reproduction instructing unit 45, for example, instructs the reproduction of an interjection voice Vy when the time length of an utterance voice Vx exceeds a predetermined value, but does not instruct the reproduction of the interjection voice Vy when the time length of the utterance voice Vx is shorter than the predetermined value.

A configuration can also be preferably adopted in which the first reproduction instructing unit 45 determines according to a response voice Vz whether or not to instruct the reproduction of an interjection voice Vy. For example, it is also possible to determine according to the content of a response voice Vz whether or not to instruct the reproduction of an interjection voice Vy. The first reproduction instructing unit 45, for example, instructs the reproduction of an interjection voice Vy when the content of a response voice Vz is a sentence constituted of plural words, but does not instruct the reproduction of the interjection voice Vy when the content of the response voice Vz is configured of one word (for example, a demonstrative pronoun “soko” (“there”)). It is also possible to determine according to the time length of a response voice Vz whether or not to instruct the reproduction of an interjection voice Vy. The first reproduction instructing unit 45, for example, instructs the reproduction of an interjection voice Vy when the time length of a response voice Vz exceeds a predetermined value, but does not instruct the reproduction of the interjection voice Vy when the time length of the response voice Vz is shorter than the predetermined value. As is understood from the above explanation, a configuration can also be preferably adopted in which whether or not to instruct the reproduction of an interjection voice Vy is determined according to an utterance voice Vx or a response voice Vz. According to the configuration described above, a natural voice dialogue closer to a real dialogue can be imitated as compared with a configuration in which a preceding voice is always reproduced without depending on an utterance voice Vx or a response voice Vz. In the second embodiment, it is also possible to determine according to an utterance voice Vx or a response voice Vz whether or not to instruct the reproduction of an interjection voice Vw.

(7) In each embodiment described above, the reproduction of an interjection voice Vy is instructed at the time point tY on the way of the standby period Q, but the time point tY, at which the reproduction of an interjection voice Vy is instructed, can be set variably according to the time length of an utterance voice Vx or a response voice Vz. For example, the time point tY, close to the time point tZ where the reproduction of a response voice Vz is started, is set when the time length of an utterance voice Vx or the response voice Vz is long (for example, in the case of the response voice Vz representing a sentence constituted of plural words), but the time point tY close to the end point tx of an utterance voice Vx is set when the time length of the utterance voice Vx or the response voice Vz is short (for example, in the case of the response voice Vz representing a single word).

As with a dialogue between real persons, the utterance of an utterance voice Vx by a user U and the reproduction of a response voice Vz with the voice dialogue apparatus 100 can be executed reciprocally multiple times. The time point tY on the way of the standby period Q thus can also be set variably according to the time length from the end point tz of a response voice Vz to the time point tX where the next utterance voice Vx is started by a user. According to the configuration described above, a dialogue with the voice dialogue apparatus 100 can be advantageously achieved at the user's pace of utterance. A configuration can also be adopted in which the time point tY, at which the reproduction of an interjection voice Vy is instructed, is set at random every dialogue.

(8) Each embodiment described above shows by way of example the configuration in which the voice signal Y2 of an interjection voice Vy is generated by adjusting the pitch of the voice signal Y1 stored in the storage device 22 according to the pitch Pz of a response voice Vz, but the method of generating the voice signal Y2 representing an interjection voice Vy is not limited to the examples described above. For example, a configuration can also be preferably adopted in which the voice signal Y2 representing the voice (that is, the interjection voice Vy) uttering the character sequence of the interjection “eto” (“er”) is generated by the known voice synthesis technology. Specifically, the pitch adjusting unit 43 generates a voice signal Y2 representing an interjection voice Vy having a pitch adjusted according to the pitch Pz of a response voice Vz. That is, storing a voice signal Y1 in the storage device 22 can be omitted. As is understood from the above explanation, the method of adjusting the pitch of an interjection voice Vy according to the pitch Pz of a response voice Vz (that is, the method of generating the voice signal Y2 of an interjection voice Vy) is optional. As for the generation of the voice signal W2 of an interjection voice Vw in the second embodiment, too, the voice signal W2 representing the voice (that is, the interjection voice Vw) uttering the character sequence of the interjection “un” (“aha”) can be generated with a pitch according to the pitch Px of an utterance voice Vx, by the known voice synthesis technology. That is, the method of adjusting the pitch of an interjection voice Vw according to the pitch Px of an utterance voice Vx (that is, the method of generating the voice signal W2 of an interjection voice Vw) is optional.

(9) In each embodiment described above, the pitch of an interjection voice Vy is adjusted according to the pitch Pz of a response voice Vz, but the kind of prosody of an interjection voice Vy as an adjustment object is not limited to a pitch. The prosody is linguistical and phonetical characteristics perceivable by a voice listener, and means the properties which cannot be comprehended only from the general notation of a language (for example, a notation excluding a special notation representing prosody). The prosody can also be rephrased as the characteristics which can make a listener evoke or guess the intention or emotion of an utterer. Specifically, the prosody may contain in its concept various properties such as voice volume, variations in inflection (change in tone of a voice or intonation), tone (height or intensity of a voice), voice length (utterance length), utterance rate, rhythm (temporal change structure of tone), or accent (height or intensity accent), but a typical example of the prosody is a pitch. When adopting a configuration in which the prosody of an interjection voice Vy is adjusted according to the prosody of a response voice Vz, a natural voice dialogue can be achieved. In the second embodiment in which the pitch of an interjection voice Vw is adjusted according to the pitch Px of an utterance voice Vx, also, the kind of prosody of an interjection voice Vw as an adjustment object is not limited to a pitch.

(10) The voice dialogue apparatus 100 shown by way of example in each embodiment described above can be achieved, as described above, in cooperation with the control device 24 and the program for a voice dialogue. The program for a voice dialogue can be provided in a form of being stored in a computer readable storage medium and installed in a computer. The recording medium is, for example, a non-transitory recording medium, a preferred example of which is an optical recording medium (optical disc) such as a CD-ROM, but can include recoding media of the known optional formats such as a semiconductor recording medium or a magnetic recording medium. The program can also be distributed to a computer in the form of communication via a communication network.

(11) The present disclosure can also be specified as the operation method (voice dialogue method) of the voice dialogue apparatus 100 according to each embodiment described above. The computer (voice dialogue apparatus 100) as the operation subject of the voice dialogue method is a system configured of a single computer or plural computers. Specifically, the voice dialogue method according to a preferred aspect of the present disclosure includes: a pitch adjusting step of adjusting a pitch of a preceding voice, which is reproduced before a dialogue voice for a dialogue, according to a pitch of the dialogue voice; a first reproduction instructing step of instructing reproduction of the preceding voice having been adjusted by the pitch adjusting step; and a second reproduction instructing step of instructing reproduction of the dialogue voice after the reproduction of the preceding voice by the first reproduction instructing step.

(12) For example, the following configurations are understood from the modes shown above by way of example.

<First Aspect>

The voice dialogue method according to a preferred aspect (first aspect) of the present disclosure includes: a pitch adjusting step of adjusting a pitch of a preceding voice, which is reproduced before a dialogue voice for a dialogue, according to a pitch of the dialogue voice; a first reproduction instructing step of instructing reproduction of the preceding voice having been adjusted in the pitch adjusting step; and a second reproduction instructing step of instructing reproduction of the dialogue voice after the reproduction of the preceding voice by the first reproduction instructing step. When a real person sequentially utters plural voices, pitches of individual voices tend to be mutually affected (that is, the pitch of a preceding voice depends on the pitch of a succeeding voice). According to the method described above, a preceding voice with a pitch adjusted according to a pitch of a dialogue voice is reproduced before the reproduction of the dialogue voice, so that a natural voice dialogue imitating the tendency described above can be achieved.

<Second Aspect>

In the voice dialogue method according to a preferred example (second aspect) of the first aspect, the dialogue voice is a response voice to an utterance voice, the preceding voice is a voice of an interjection, and the first reproduction instructing step instructs the reproduction of the preceding voice in a standby period from the utterance voice to the reproduction of the response voice. In a dialogue between real persons, any voice (typically, an interjection) tends to be uttered by a dialogue partner between an utterance voice by an utterer and a response voice pronounced by the dialogue partner. According to the method described above in which a voice of an interjection is reproduced before the reproduction of a response voice to an utterance voice, a natural voice dialogue imitating the tendency of a real dialogue can be achieved. When an utterer sequentially utters an interjection voice and a response voice, the pitch of the interjection voice remarkably tends to depend on the pitch of the immediate response voice. Thus, according to the method described above in which a voice of an interjection is reproduced before the reproduction of a response voice to an utterance voice, the above described effect that a natural voice dialogue can be achieved is particularly effective.

<Third Aspect>

In the voice dialogue method according to a preferred example (third aspect) of the first aspect or the second aspect, the pitch adjusting step adjusts the pitch of the preceding voice according to the pitch near an end point of the dialogue voice. According to the method described above, a preceding voice with the pitch according to the pitch near an end point of a dialogue voice is reproduced, so that the effect, in which a natural voice dialogue close to a real dialogue can be achieved, is particularly remarkable.

<Fourth Aspect>

In the voice dialogue method according to a preferred aspect (fourth aspect) of the third aspect, the pitch adjusting step adjusts the pitch at the end point of the preceding voice so as to match the minimum pitch near the end point out of the dialogue voice. According to the method described above, a preceding voice is reproduced so that the pitch at the end point of the preceding voice matches the minimum pitch near the end point of a dialogue voice, whereby the effect, in which a natural voice dialogue close to a real dialogue can be achieved, is particularly remarkable.

<Fifth Aspect>

In the voice dialogue method according to a preferred example (fifth aspect) of the second aspect, the first reproduction instructing step includes determining whether or not to instruct the reproduction of the preceding voice according to the utterance voice or the dialogue voice. According to the method described above, whether or not to instruct the reproduction of a preceding voice is determined according to an utterance voice or a dialogue voice, so that a natural voice dialogue closer to a real dialogue can be imitated as compared with the method in which a preceding voice is always reproduced without depending on an utterance voice or a dialogue voice.

<Sixth Aspect>

In the voice dialogue method according to a preferred example (sixth aspect) of the fifth aspect, the first reproduction instructing step determines whether or not to instruct the reproduction of the preceding voice according to a time length of the utterance voice or the dialogue voice. According to the method described above, whether or not to reproduce a preceding voice is determined according to the time length of an utterance voice or a dialogue voice.

<Seventh Aspect>

In the voice dialogue method according to a preferred example (seventh aspect) of the second aspect, the first reproduction instructing step instructs the reproduction of the preceding voice at a time point according to the time length of the utterance voice or the dialogue voice in the standby period. According to the method described above, a preceding voice is reproduced at a time point according to the time length of an utterance voice or a dialogue voice in the standby period, so that mechanical impression given to a user can be reduced as compared with a configuration in which a time point where a preceding voice is reproduced does not change regardless of the time length of an utterance voice or a dialogue voice.

<Eighth Aspect>

In the voice dialogue method according to a preferred example (eighth aspect) of the second aspect, the pitch adjusting step adjusts the pitch of an initial voice, which is reproduced before the preceding voice, according to the pitch of the utterance voice, and the first reproduction instructing step instructs the reproduction of the adjusted initial voice in the standby period and the reproduction of the preceding voice in the standby period after the reproduction of the initial voice. According to the method described above, an initial voice with a pitch according to the pitch of an utterance voice is reproduced in a period from the utterance voice to the reproduction of a preceding voice, so that a natural voice dialogue closer to a real dialogue can be imitated/.

<Ninth Aspect>

The voice dialogue apparatus according to a preferred aspect (ninth aspect) of the present disclosure includes: a pitch adjusting unit configured to adjust a pitch of a preceding voice, which is reproduced before a dialogue voice for a dialogue, according to a pitch of the dialogue voice; a first reproduction instructing unit configured to instruct reproduction of the preceding voice having been adjusted with the pitch adjusting unit; and a second reproduction instructing unit configured to instruct reproduction of the dialogue voice after the reproduction of the preceding voice with the first reproduction instructing unit. When a real person sequentially utters plural voices, pitches of individual voices tend to be mutually affected (that is, the pitch of a preceding voice depends on the pitch of a succeeding voice). According to the configuration described above, a preceding voice with a pitch adjusted according to the pitch of a dialogue voice is reproduced before the reproduction of the dialogue voice, so that a natural voice dialogue imitating the tendency described above can be achieved.

The present disclosure can achieve a natural voice dialogue and so is useful.

What is claimed is:

1. A voice dialogue method, comprising:
a pitch adjusting step of shifting pitches of an entire period of a preceding voice, which is reproduced before a dialogue voice for a dialogue, according to a pitch of the dialogue voice;
a first reproduction instructing step of instructing reproduction of the preceding voice having been adjusted in the pitch adjusting step; and
a second reproduction instructing step of instructing reproduction of the dialogue voice after the reproduction of the preceding voice by the first reproduction instructing step.

2. The voice dialogue method according to claim 1, wherein
the dialogue voice is a response voice to an utterance voice,
the preceding voice is a voice of an interjection, and
the first reproduction instructing step instructs the reproduction of the preceding voice in a standby period from the utterance voice to reproduction of the response voice.

3. The voice dialogue method according to claim 1, wherein
the pitch adjusting step adjusts the pitch of the preceding voice according to a pitch in a last interval out of the dialogue voice.

4. The voice dialogue method according to claim 3, wherein
the pitch adjusting step adjusts the pitch at an end point of the preceding voice so as to match a minimum pitch in the last interval out of the dialogue voice.

5. The voice dialogue method according to claim 2, wherein
the first reproduction instructing step includes determining whether or not to instruct the reproduction of the preceding voice according to the utterance voice or the dialogue voice.

6. The voice dialogue method according to claim 5, wherein
the first reproduction instructing step determines whether or not to instruct the reproduction of the preceding voice according to a time length of the utterance voice or the dialogue voice.

7. The voice dialogue method according to claim 2, wherein
the first reproduction instructing step instructs the reproduction of the preceding voice at a time point according to a time length of the utterance voice or the dialogue voice in the standby period.

8. The voice dialogue method according to claim 2, wherein
the pitch adjusting step adjusts a pitch of an initial voice, which is reproduced before the preceding voice, according to a pitch of the utterance voice, and
the first reproduction instructing step instructs reproduction of the adjusted initial voice in the standby period and the reproduction of the preceding voice in the standby period after the reproduction of the initial voice.

9. A voice dialogue apparatus, comprising:
a memory storing instructions; and
a processor configured to implement the instructions and execute a plurality of tasks, including:
a pitch adjusting task that shifts pitches of an entire period of a preceding voice, which is reproduced before a dialogue voice for a dialogue, according to a pitch of the dialogue voice;
a first reproduction instructing task that instructs reproduction of the preceding voice having been adjusted with the pitch adjusting task; and
a second reproduction instructing task that instructs reproduction of the dialogue voice after the reproduction of the preceding voice with the first reproduction instructing task.
